(19) United States
(12) Patent Application Publication
(10) Pub. No.: US 2025/0302689 A1
(43) Pub. Date: Oct. 2, 2025

(54) MEDICAL VACUUM SUCTION DEVICE

(71) Applicant: Geoffrey Daigle, Cohasset, MN (US)

(72) Inventor: Geoffrey Daigle, Cohasset, MN (US)

(21) Appl. No.: 18/622,085

(22) Filed: Mar. 29, 2024

(51) Int. Cl. A61H 9/00

(52) U.S. Cl. CPC A61H 9/0057; A61H 2201/1238; A61H 2201/1635; A61H 2201/164; A61H 2201/165; A61H 2201/5056; A61H 2201/5071; A61H 2205/06; A61H 2205/106; A61H 2205/108; A61H 2205/12

(57) ABSTRACT

The Pain Reduction Tool is the only product of its kind that simplifies the pain management process by treating an entire extremity, via a vacuum chamber, under the supervision of a medical professional. Whether the agenda is to treat an arm or a leg suffering from pain and/or dysfunction, this device provides precision and efficiency, making it a versatile and essential tool that was solely designed by an Orthopedic Manual Physical Therapist. Embodiments of the disclosure are comprised of but not limited to durable PVC materials based on manufacturing and functionality needs. The disclosure offers controllable vacuum pressure selections and can be pre-programmed by a provider to support at-home, and independent use by a patient.

### BACKGROUND

The neuromusculoskeletal system refers to an integrated, complex relationship between the nervous, muscular, and skeletal systems of the body, coordinated by the brain and central nervous system. When there is pain, due to damage caused by injury, overexertion and/or long-term sedentary positioning, it can be a challenge to manage. Traditional methods used for neuromusculoskeletal pain, such as: vacuum cups, can be site-specific and address only small areas of pain whereas larger chambers designed for the lower body tend to be inconvenient for clinical use. There have been no products available as original equipment or as an aftermarket to address this problem.

An apparatus to help manage neuromusculoskeletal pain in both small areas and larger areas in a practical way as needed is not being met by any known device or system at present. There have been no products available as original equipment or as an aftermarket to address this problem either.

### SUMMARY OF THE INVENTION

The main purpose of the Medical Vacuum Suction Device is to provide users with a neuromusculoskeletal pain reduction device that offers a holistic solution to addressing a wide range of neuromusculoskeletal pain conditions.

The high and low pressure medical device is engineered to operate over a range of −350 mmHg to 950 mmHg and withstand up to −400-2000 mmHg. The disclosed device has a rigid enclosure resembling a body appendage and includes an insertion end and a free end a plurality of hermetically sealed seams there between to facilitate a movement there between. The high pressure medical device also includes a flexible seal disposed on each of the insertion end and the free end and configured to hermetically seal a pressure inside the rigid enclosure via respective three concentric ‘U’ grooves. An adjustable locking lever band tightens around the flexible seal and collapses the three concentric ‘U’ grooves around the chamber surrounding the body appendage for a hermetic seal thereto.

### BRIEF DESCRIPTION OF THE DRAWINGS

FIG. 1 is a front perspective view of a long boot Medical Vacuum Suction Device in accordance with an embodiment of the present disclosure.

FIG. 2 is a front perspective view of a full leg boot Medical Vacuum Suction Device in accordance with an embodiment of the present disclosure.

FIG. 3 is a front perspective view of a short chamber cap end Medical Vacuum Suction Device in accordance with an embodiment of the present disclosure.

FIG. 4 is a front perspective view of a long chamber cap end Medical Vacuum Suction Device in accordance with an embodiment of the present disclosure.

FIG. 5 is a front perspective view of a long chamber seal end Medical Vacuum Suction Device in accordance with an embodiment of the present disclosure.

FIG. 6 is a front perspective view of a short chamber seal end Medical Vacuum Suction Device in accordance with an embodiment of the present disclosure.

FIG. 7 is a front perspective view of a short boot Medical Vacuum Suction Device in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

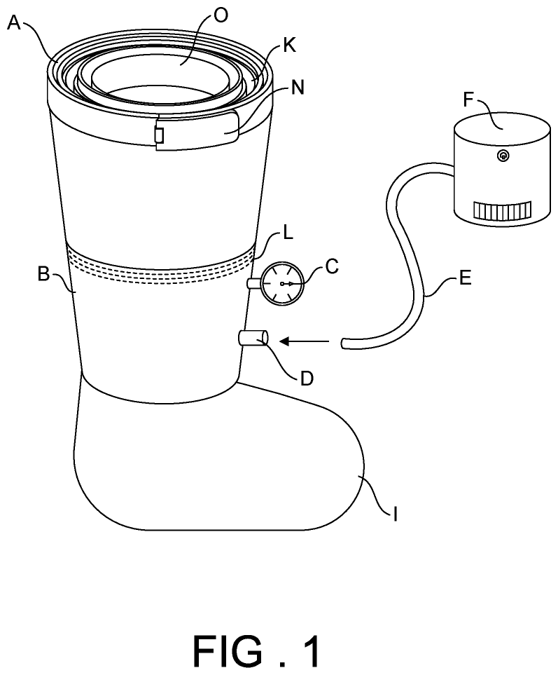

FIG. 1 is a front perspective view of a long boot Medical Vacuum Suction Device showing: flexible closure seal referenced as A, leg chamber referenced as B, gauge referenced as C, valve (for positive and/or negative pressure) referenced as D, air hose referenced as E, vacuum and/or pressure pump (manual or electric) referenced as F, foot chamber referenced as I, rigid support to flexible closure seal referenced as K, tight seal joint (threaded or U-channel) referenced as L, locking lever clamp referenced as N, sleeve/gasket extension referenced as O, in accordance with an embodiment of the present disclosure.

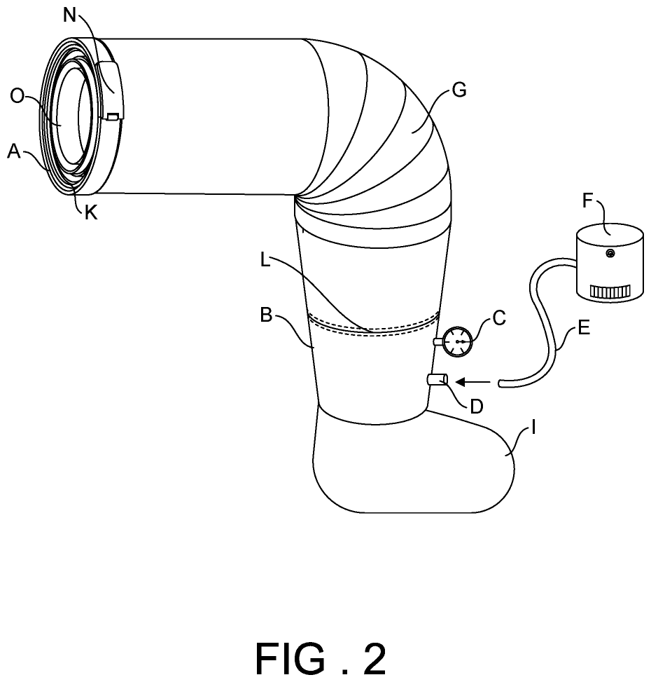

FIG. 2 is a front perspective view of a full leg boot Medical Vacuum Suction Device showing: flexible closure seal referenced as A, leg chamber referenced as B, gauge referenced as C, valve (for positive and/or negative pressure) referenced as D, air hose referenced as E, vacuum and/or pressure pump (manual or electric) referenced as F, rigid knee joint referenced as G, foot chamber referenced as I, rigid support to flexible closure seal referenced as K, tight seal joint (threaded or U-channel) referenced as L, locking lever clamp referenced as N, sleeve/gasket extension referenced as O, in accordance with an embodiment of the present disclosure.

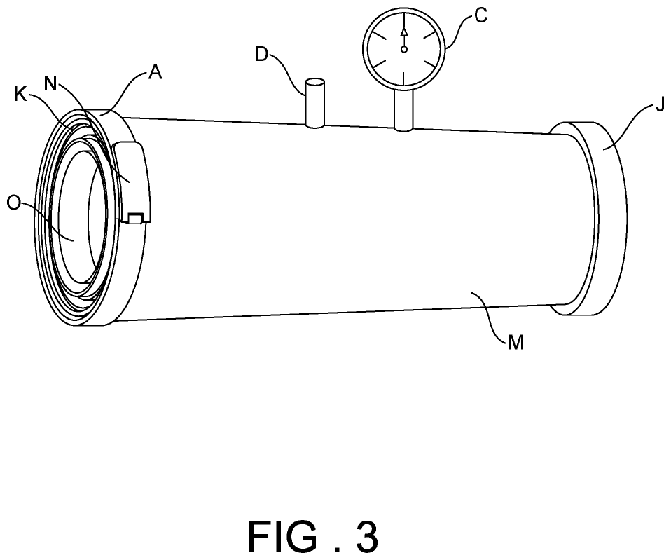

FIG. 3 is a front perspective view of a short chamber cap end Medical Vacuum Suction Device showing: flexible closure seal referenced as A, valve (for positive and/or negative pressure) referenced as D, capped or uncapped end referenced as J, rigid support to flexible closure seal referenced as K, short chamber referenced as M, locking lever clamp referenced as N, sleeve/gasket extension referenced as O, in accordance with an embodiment of the present disclosure.

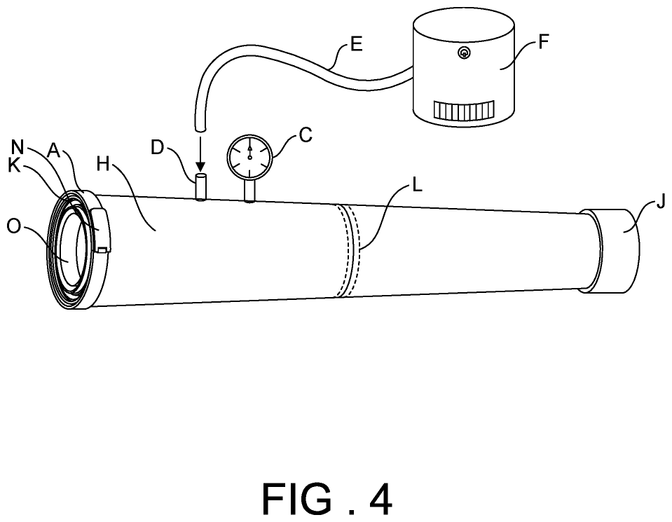

FIG. 4 is a front perspective view of a long chamber cap end Medical Vacuum Suction Device showing: flexible closure seal referenced as A, gauge referenced as C, valve (for positive and/or negative pressure) referenced as D, air hose referenced as E, vacuum and/or pressure pump (manual or electric) referenced as F, arm chamber referenced as H, capped or uncapped end referenced as J, rigid support to flexible closure seal referenced as K, tight seal joint (threaded or U-channel) referenced as L, locking lever clamp referenced as N, sleeve/gasket extension referenced as O, in accordance with an embodiment of the present disclosure.

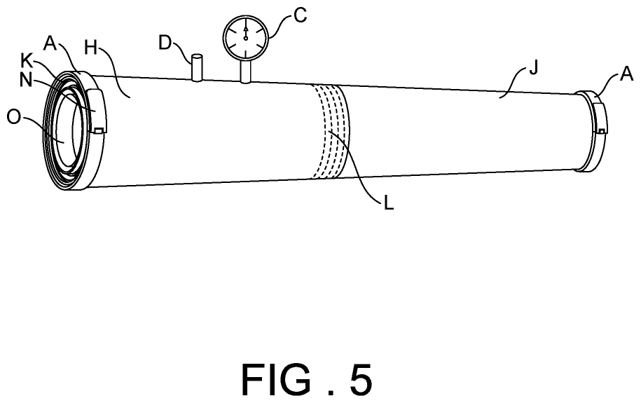

FIG. 5 is a front perspective view of a long chamber seal end Medical Vacuum Suction Device showing: flexible closure seal referenced as A, gauge referenced as C, valve (for positive and/or negative pressure) referenced as D, arm chamber referenced as H, capped or uncapped end referenced as J, rigid support to flexible closure seal referenced as K, tight seal joint (threaded or U-channel) referenced as L, short chamber referenced as M, locking lever clamp referenced as N, sleeve/gasket extension referenced as O, in accordance with an embodiment of the present disclosure.

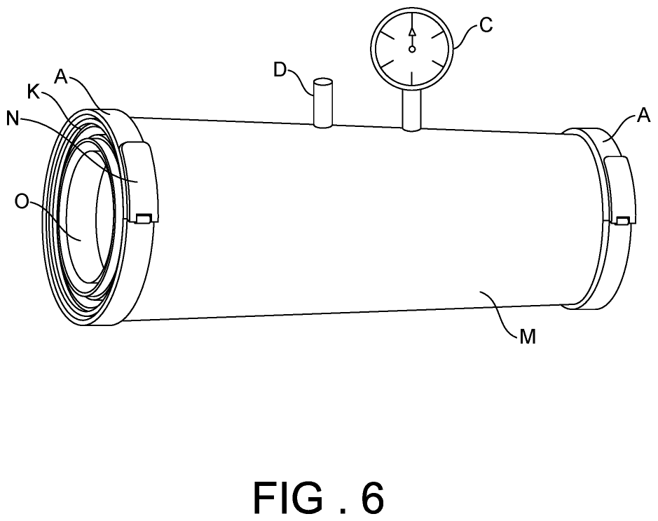

FIG. 6 is a front perspective view of short chamber seal end Medical Vacuum Suction Device showing: flexible closure seal referenced as A, gauge referenced as C, valve (for positive and/or negative pressure) referenced as D, rigid support to flexible closure seal referenced as K, short chamber referenced as M, locking lever clamp referenced as N, sleeve/gasket extension referenced as O, in accordance with an embodiment of the present disclosure.

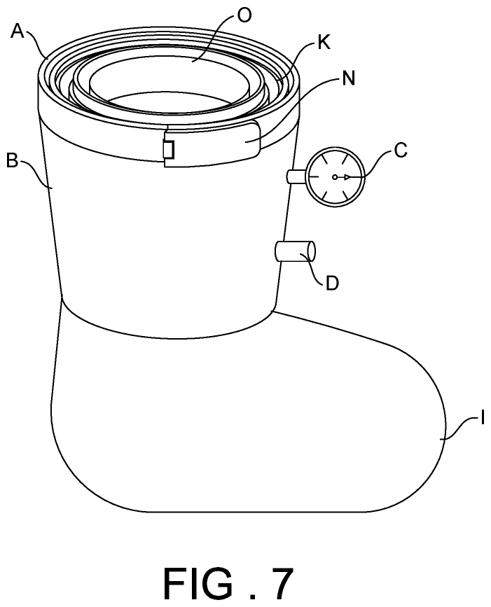

FIG. 7 is a front perspective view of a short boot Medical Vacuum Suction Device showing: flexible closure seal referenced as A, leg chamber referenced as B, gauge referenced as C, valve (for positive and/or negative pressure) referenced as D, foot chamber referenced as I, rigid support to flexible closure seal referenced as K, locking lever clamp referenced as N, sleeve/gasket extension referenced as O, in accordance with an embodiment of the present disclosure.

Embodiments include a bent chamber version to the arm tube or arm chamber as well as the leg chamber. A quick release on the flexible seal to the tube or chamber wall is also disclosed in the embodiments.

The present disclosed Medical Vacuum Suction Device, also known as “Pain Reduction Tool”, offers a modern accessory that permits increased treatment coverage for a person's limb (arm or leg) while maintaining clinical practicality. Introducing a novel pressure chamber, the Pain Reduction Tool alleviates a multitude of potential pain conditions by improving outcomes. The working prototype, for the arm only, of this innovative medical tool is crafted from durable PVC and incorporates a monitoring system to ensure that the negative pressure remains within safe and therapeutics parameters throughout treatment.

Embodiments also incorporate a monitoring system to ensure that the negative pressure remains within safe and therapeutic parameters throughout treatment. For added convenience, it can be equipped with either a manual or automatic pump, allowing practitioners to achieve the desired negative pressure levels to successfully address a targeted area of the body as they treat: peripheral nerve entrapment, tennis elbow, carpal tunnel, thumb pain and other similar and diverse physical ailments. This innovative, top-quality product allows for an increased ability to treat specific limb areas such as: arm, leg and feet when compared to vacuum cups, and is more effective in duration of time than standard medical techniques.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A pressure medical device comprising:
a rigid enclosure resembling a body appendage and comprising an insertion end and a free end a plurality of seams there between;
a flexible seal disposed on each of the insertion end and the free end and configured to hermetically seal a pressure inside the rigid enclosure via respective three concentric ‘U’ grooves; and
an adjustable locking lever band configured to tighten around the flexible seal and collapse the three concentric ‘U’ grooves onto the chamber wall surrounding the body appendage for a hermetic seal thereto.

2. The pressure medical device of claim 1, further comprising an air pressure gauge configured to measure an air pressure inside the rigid enclosure.

3. The pressure medical device of claim 1, further comprising a knee joint in the rigid enclosure.

4. The pressure medical device of claim 1, further comprising an elbow joint in the rigid enclosure.

5. The pressure medical device of claim 1, further comprising a foot chamber in the rigid enclosure.

6. The pressure medical device of claim 1, further comprising a vacuum pump having access inside the rigid enclosure.

7. The pressure medical device of claim 1, further comprising a leg tube in the rigid enclosure.

8. The pressure medical device of claim 1, further comprising a leg tube extending to just below a knee of a user of the device.

9. The pressure medical device of claim 1, further comprising an arm tube in the rigid enclosure.

10. The pressure medical device of claim 1, further comprising a high pressure air valve configured to manage an air pressure inside the rigid enclosure.

11. The pressure medical device of claim 1, further comprising an air hose configured to transfer an air pressure inside the rigid enclosure to an accessory device.

12. The pressure medical device of claim 1, wherein the free end comprises a locking lever holding the flexible seal onto the chamber wall surrounding the body appendage.

13. The pressure medical device of claim 1, wherein the free end comprises a cap closure.

14. The pressure medical device of claim 1, wherein the free end comprises a boot closure.

15. The pressure medical device of claim 1, wherein the adjustable locking lever band comprises an adjustable clasp lever.

16. The pressure medical device of claim 1, wherein the pressure ranges from −350 mmHg to 950 mmHg.

17. The pressure medical device of claim 1, wherein an upper positive bound of the pressure includes 2000 mmHg.

18. The pressure medical device of claim 1, wherein a lower pressure bound of the pressure includes −400 mmHg.
